(19) United States
(12) Patent Application Publication
(10) Pub. No.: US 2004/0205581 A1
(43) Pub. Date: Oct. 14, 2004

(54) Hierarchical storage

(76) Inventor: Fabio M. Gava, Irvine, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/156,345

(22) Filed: Jul. 15, 2002

(51) Int. Cl. G06F 17/24; G06F 17/21

(52) U.S. Cl. 715/513

(57) ABSTRACT

A system and method is provided for implementing hierarchical storage of information. The system comprises a hierarchical repository having at least two levels. The first level comprises a folder and a markup language based file within the folder for storing information. Also stored within the folder is a second level folder which also has a markup language based file stored within the folder. In order to access the repository, a user interface is provided.

### BACKGROUND OF THE INVENTION

This invention pertains generally to information management, and more particularly to a hierarchical storage system for managing information.

In the Microsoft Windows family of operating systems (“OS”), beginning with Windows 95, the operating system implements a registry, which acts is a single location for storing information. Such information suitably includes OS-dependent system settings, such as hardware information, selected system options, computer memory configuration, application program information, peripheral device information, system policy information, etc. In a network environment, for example, registry information on a server can be managed centrally and can be used to store system policies for individuals and workgroups.

The Windows registry has a hierarchical structure to facilitate management of the various types of information stored within the registry. The hierarchical structure creates an organized information set. Other OS, however, do not use a hierarchical organizational structure for saving information. Therefore, developers are forced to use other methods of storing information when developing for non-Windows platforms. In such instances, developers may use plain text files, either stored in a single location or scattered throughout a file system, to store information relating to a developed program.

For example, when developing embedded system software for controlling configurable digital imaging devices (“DID”) storage for configuration parameters must be provided. In the Windows environment, configuration parameters are stored in the registry. In the Linux environment, however, configuration parameters are stored in text-based configuration files. Consequently, configurable DIDs are generally dependent on an OS to receive configuration information. Therefore, when OS configuration settings change, new software must be written, compiled, provided to customers, and installed. It would be preferable if the software were platform independent such that a single version of a DID software program could accommodate multiple OS. Therefore, it would preferable if DID software programs accessed configuration parameters stored independently of such OS-specific configuration.

One method of implementing a OS-independent information storage is to implement a markup language based file having a plurality of sections for storing information. For example, accessing data stored in an extensible markup language (“XML”) file is suitably accomplished through the use of an XML parser that is Document Object Model (“DOM”) compliant. XML is a universal syntax for describing and structuring data independent from application logic. XML can be used to define unlimited languages for specific industries and applications. XML is a text-based syntax that is readable by both computer and humans which offers data portability and reusability across different platforms and devices. The DOM is a platform- and language-neutral interface that allows programs and scripts to dynamically access and update the content, structure and style of documents. The document can be further processed and the results of that processing can be incorporated back into the presented page.

DOM compliant parsers read an entire XML file and create in memory a tree structure that mirrors the hierarchical nature of the data. The content of the XML document is accessible through a root element, whose attributes, contents and sub-elements can be inspected. Given the names of a sequence of nested XML elements, it is possible to reach any contained element, its attributes and content, by traversing the tree beginning from the root element and following the given sequence of element names. It is also possible to promote changes both on the structure and contained information, by adding, deleting or changing elements and its data. Therefore, an XML based repository allows for hierarchical structure while maintaining cross-platform functionality.

Using an XML file to implement information storage can be problematic because once an XML file is loaded into a process memory address space, changing the memory content does not guarantee persistency. Consequently, any change made to a memory space must be rewritten back to the XML document to maintain persistency. When the XML file is a large document, this becomes a cumbersome and relatively time intensive task. It would be preferable if there were a more efficient cross-platform storage system.

### SUMMARY OF THE INVENTION

In accordance with the present invention, there is provided a hierarchical information storage system. The storage system comprises a hierarchical repository which has at least one first level folder for storing at least first and second data sets and at least one first level markup based file stored within the at least one first level folder, the first level markup based file storing information relative to at least a portion of the first data set. The repository also comprises at least one second level folder stored within the at least one first level folder. The second level folder stores information relative to the second data set. Within the second level folder is at least one second level markup based file. The second level markup based file comprises information relative to at least a portion of the second data set. In addition, the hierarchical information storage system comprises an interface communicatively coupled to the repository for handling communications with the repository, the interface comprising computer readable code on a computer readable medium.

### BRIEF DESCRIPTION OF THE FIGURES

FIGS. 1A-B are representations of a hierarchical markup language based information storage file;

FIG. 2A is a representation of the structure of a hierarchical storage system according to the present invention;

FIG. 2B is a representation of a hierarchical storage system for storing information contained in the hierarchical repository file of FIG. 1B;

FIGS. 3A-D are representations of a plurality of files in the hierarchical storage system of FIG. 2B;

FIG. 4 is an overall system of the present invention in a network environment;

FIG. 5 is a flowchart generally depicting a method for interfacing with the hierarchical storage system of the present invention;

FIG. 6A is a flowchart generally depicting a method for creating elements in the hierarchical storage system of the present invention; and

FIG. 6B is a flowchart generally depicting a method for creating elements in a hierarchical markup language file.

### DETAILED DESCRIPTION OF THE INVENTION

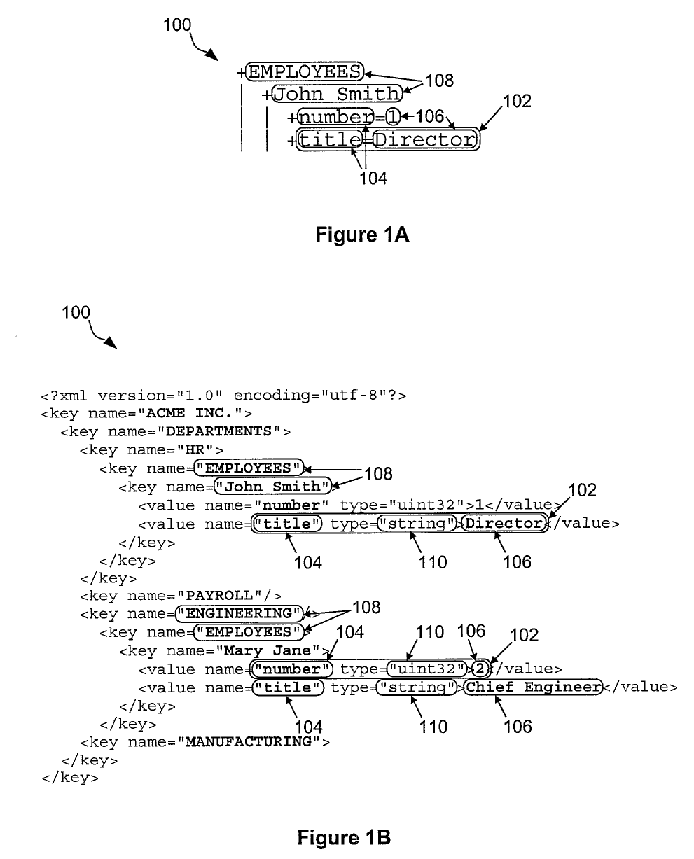

Turning now to FIG. 1A, an illustration of the general structure of a hierarchical markup language based information storage file 100 is disclosed. As shown, the information storage file 100 suitably stores pairs 102 of storage names 104 and values 106. The name 104 and value 106 pairs 102 are suitably grouped according to the information to which they correspond and are preferably grouped in keys 108.

Turning now to FIG. 1B, an illustration of a portion of an exemplary hierarchical markup language based information storage file 100 is disclosed. The organizational structure of information storage file 100 is suitably the same as the structure shown in FIG. 1A. The information storage file 100 is suitably a markup language based file, such as HTML, SGML, or XML, although any markup language is suitably used as will be appreciated by those skilled in the art. In the presently preferred embodiment, the information storage file 100 is an XML file. XML offers data portability and reusability across different platforms and devices. It is also flexible and extensible, allowing new tags to be added without breaking an existing document structure. Based on Unicode, XML provides global language support.

Markup suitably describes and structures content, by using various XML structures, such as element types, attributes, entity references, character data (“CDATA”) sections and document type declarations. It can comply with the pre-defined grammar of document type definitions (“DTD”) or can be defined as the document instance is created. Markup is any part of the document instance that starts with “<” or “&”. It describes content, but is not read as character data, it is the actual content of the document.

The information storage file 100 suitably stores name and value pairs 102. The name 104 and value 106 pairs 102 are suitably grouped according to the information they store and preferably grouped in keys 108. Furthermore, keys 108 are suitably grouped under other keys 108, creating a multi-level organizational structure. Name and value pairs 102 are preferably grouped in a key 108 and comprise stored information. Keys 108 preferably provide the organizational structure of the stored information. The name 104 preferably defines the information stored and the value 106 preferably stores the information. For example, a name 104 and value 106 pair 108 suitably consists of “title” and “Director”. The name 104 is “title” and the value 106 is “Director”. In other words, the “title” is “Chief Engineer”. In this manner, a name 104 functions as does a field in a database and a value 106 functions as does the data stored in the field.

In addition, for each value, there preferably comprises a type 110. In the presently preferred embodiment, the type is either string, unsigned integer, or binary, although it will be understood by those skilled in the art that other data storage types are suitably used. The type 110 preferably defines the type of information stored in the value 106. In the case where the name 104 is “title” and the value 106 is “Director”, the type 110 is suitably “string”.

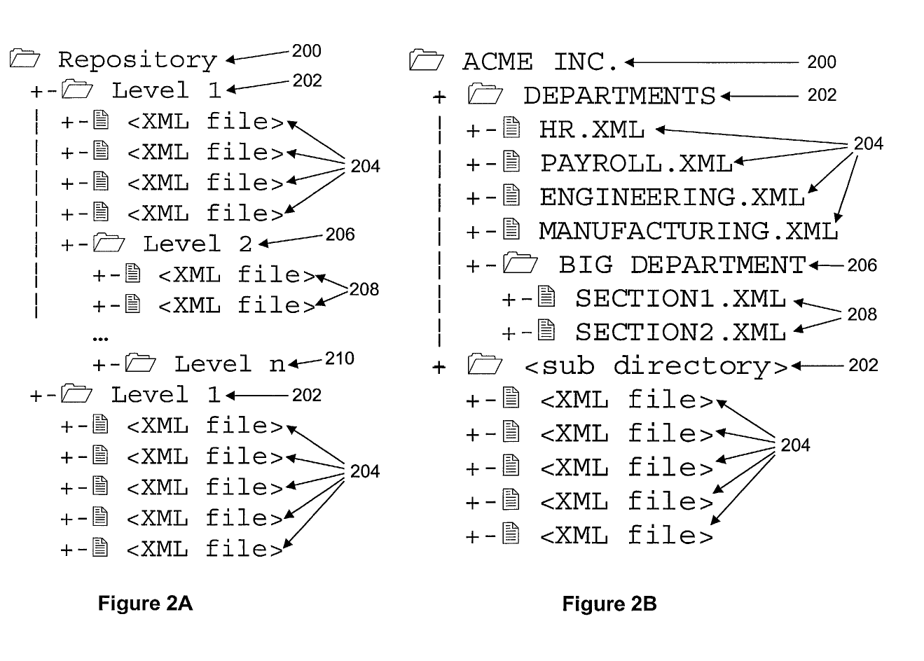

Turning now to FIGS. 2A-B, FIG. 2A discloses the general structure of the hierarchical information storage system according to the present invention and FIG. 2B discloses the hierarchical information storage system as applied to the file of FIG. 1B. The information storage system 100 is suitably a repository 200 comprising a plurality of levels. The repository preferably comprises a first storage level. The first storage level preferably comprises at least one storage container. In the presently preferred embodiment, the storage container is a first level folder 202. The first level folder 202 is suitably a folder at any level other than the bottommost level of the repository 200. Stored within the first level folder 202 is preferably at least one first level markup based file 204. In the presently preferred embodiment, the markup based file is an XML file, although HTML, SGML, or any other markup language is suitably used, as will be appreciated by those skilled in the art.

Also stored within the at least one first level folder 202 is at least one second level folder 206. The second level folder 206 is suitably a folder at any level other than the topmost level of the repository 200. Like the first level folder 202, at least one first level markup based file 208 is preferably stored within the at least one second level folder 206. In the presently preferred embodiment, the markup based file is an XML file, although HTML, SGML, or any other markup language is suitably used, as will be appreciated by those skilled in the art. In addition to the at least one markup based file 208, the second level folder suitably comprises at least one lower level folder 210, which in turn comprises additional files, which are suitably files of any type. In addition, the lower level folder 210 suitably comprises at least one additional folder. Each folder in the repository 200 preferably comprises at least one markup language based file.

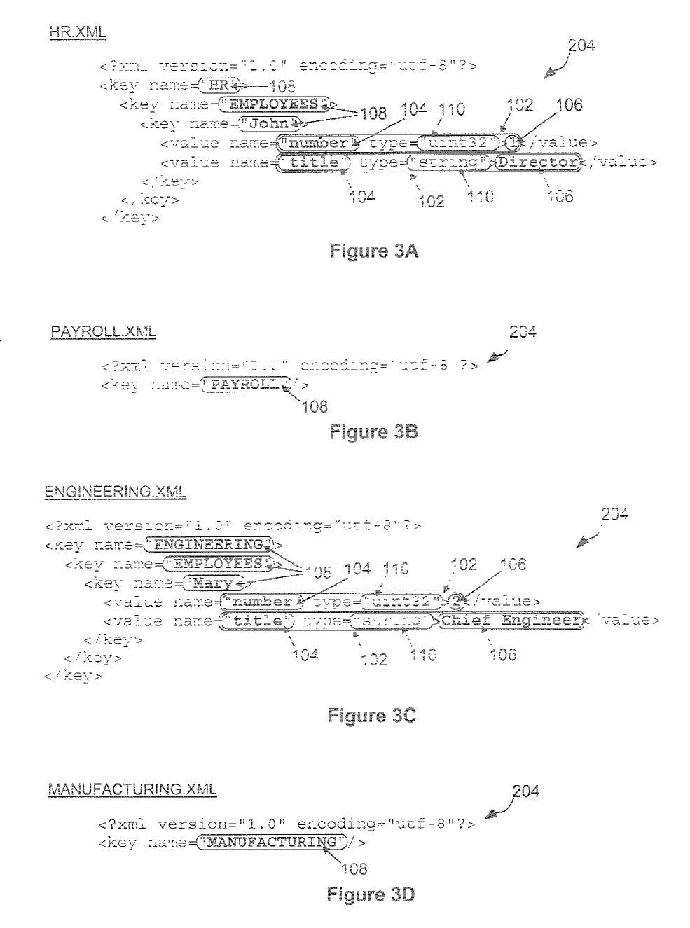

Turning now to FIGS. 3A-D, representations of a plurality of markup language based files disclosed in the hierarchical storage system of FIG. 2B. Like the file represented in FIGS. 1A-B, the files represented in FIGS. 3A-D are preferably markup based files that store pairs 102 of storage names 104 and values 106. The name 104 and value 106 pairs 102 are suitably grouped according to the information to which they correspond and are preferably grouped in keys 108.

Turning now to FIGS. 3A and 3C, illustrations of portions of exemplary first level markup based files 204 are disclosed. While only first level markup based files 204 are shown, the structure of the markup based files on all levels is preferably the same as that shown for the first level markup based files 204. The first level markup based file 204 is suitably any markup language based file, such as HTML, SGML, or XML, although any markup language is suitably used as will be appreciated by those skilled in the art. In the presently preferred embodiment, the first level markup based file 204 is an XML file. The first level markup based file 204 suitably stores name and value pairs 102. The name and value pairs 102 are suitably grouped according to the information they store and preferably grouped in keys 108. Furthermore, keys 108 are suitably grouped under name and value pairs 102, names 104, values 106, or other keys 108, creating a multi-level organizational structure.

FIGS. 3A and 3C show two similarly structured XML files, each with a plurality of keys 108. Each key 108 is suitably a level of organization. As shown in FIG. 3A, for example, the first key 108 or level of organization is “HR”, which is an abbreviation for “human resources” and represents the human resources department of an organization. Within the HR department of an organization are employees, which are categorized by the “EMPLOYEES” key Bump 108 nested under the “HR” key 108. The organization of nested keys 108 preferably provides a hierarchical structure within the markup based file 204. In this manner, each key 108 nested under another key 108 is analogous to a subfolder stored within a folder. Each employee in the HR department has a name. Therefore, nested under the “EMPLOYEES” key 108 is another key 108 “JOHN”, which represents the name of an employee.

Name 104 and value 106 pairs 102 are preferably grouped in a key 108 and comprise stored information. Still referring to FIG. 3A, name 104 and value 106 pairs 102 are nested under the key 108 “JOHN”. The name 104 preferably defines the information stored and the value 106 preferably stores the information. In this manner, a name 104 suitably functions as does a field in a database and a value 106 functions as does the data stored in the field. In the first pair 102, the name 104 is “number” and value 106 is “1”. Therefore, John is employee number 1. Similarly, in the second pair 102, the name 104 is “title” and value 106 is “Director”. Therefore, John's title is Director. In addition, for each value, there preferably comprises a type 110. In the presently preferred embodiment, the type is either string, unsigned integer, or binary, although it will be understood by those skilled in the art that other data storage types are suitably used. The type 110 preferably defines the type of information stored in the value 106. In the case where the name 104 is “number” and value 106 is “1”, the type is suitably unsigned integer, as represented by “uint32”, and in the case where the name 104 is “title” and the value 106 is “Director”, the type 110 is suitably “string”.

Turning now to FIGS. 3B and 3D, illustrations of portions of exemplary first level markup based files 204 are disclosed. Unlike those files illustrated in FIGS. 3A and 3C, the files do not contain any name 104 and value 106 pairs 102. In other words, files resembling those illustrated in FIGS. 3B and 3D act as empty storage units. For example, no employees are listed in FIG. 3B. If one were to add an employee, one would first suitably add a nested key such as “EMPLOYEES” under the “PAYROLL” key 108. One would then add a nested key with an employee name under the “EMPLOYEES” key. Name and value pairs nested under the employee name key are then suitably used to store information about the employee.

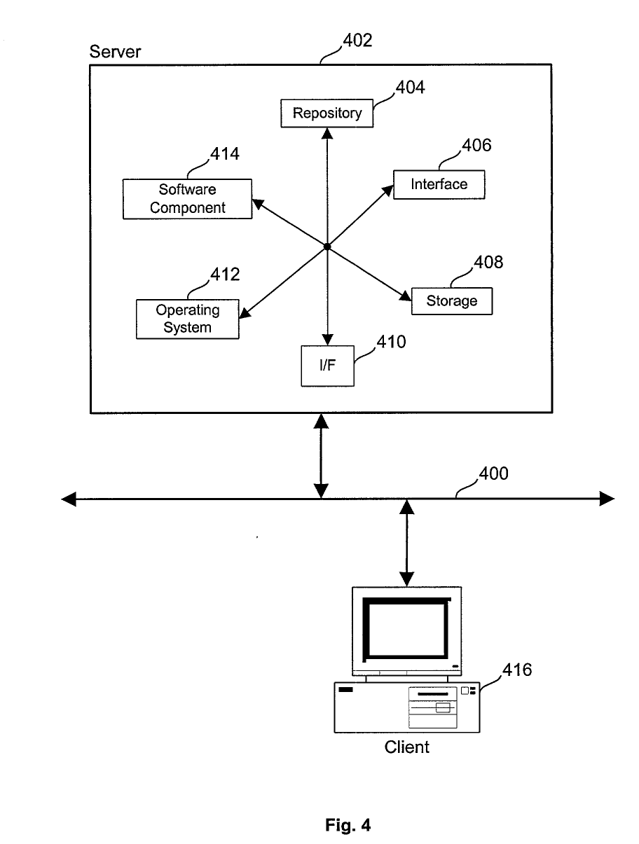

Turning now to FIG. 4, a system diagram illustrating a hierarchical storage system in a network environment in accordance with the present invention is provided. The system is preferably configurable for use in any network environment, whether peer-to-peer, client-server, or N-tier, and is suitably configurable to accommodate a plurality of users. The system comprises a data transport network 400 illustrative of a LAN or WAN environment in which a preferred embodiment is provided, such as a packet-switched TCP/IP-based global communication network. The network 400 is suitably any network and is preferably comprised of physical layers and transport layers, as illustrated by a myriad of conventional data transport mechanisms like Ethernet, Token-Ring™, 802.11(b), or other wire-based or wireless data communication mechanisms as will be apparent to one of ordinary skill in the art.

Placed in data communication with data transport system 400 is a Server 402 which is suitably any Server for accommodating selective query support, selective data access, data archiving, and the like, as will be appreciated to one of ordinary skill in the art. One or more Clients, such as representative Client 416, is also placed, or selectively placed, in data communication with the data transport system 400. The Client 416 is preferably configured to interact with Server 402 as will be appreciated by one who is skilled in the art. It should be noted that the Client 416 is suitably a Thick Client or a Thin Client, additional server(s), personal digital assistant (“PDA”), or any equipment capable of interacting with Server 402 to send and receive data. Thus, a data path between Server 402 and the one or more Clients, such as representative Client 416, are in shared data communication.

The present invention preferably comprises at least one repository 404, at least one interface 406 and at least one SC 414. It will be appreciated by those skilled in the art that any of the repository 404, interface 406 and SC 414 are suitably storable on the Server 402 or the Client 416 without departing from the scope of the present invention. Therefore, FIG. 4 is simply one possible configuration of the present invention in a network environment. In addition, the present invention is also suitably functional in a stand-alone environment. All components of the present invention would therefore reside on a single machine.

As shown, the Server 402 preferably comprises a network interface 410 through which the Server 402 interfaces with data transport system 400. The Server 402 also preferably comprises internal storage 408, which is suitably in the form of RAM and is suitably embodied as a hard disk, optical storage, removable memory, flash memory, or any other preferably rewritable storage as will be appreciated by those skilled in the art. Preferably stored on internal storage 408 are an operating system 412, a repository 404, an interface 406, and a software component (“SC”) 414. The interface 406 and SC 414 are suitably embodied as computer readable code on a computer readable medium. In the presently preferred embodiment, the software component 414 is a compiled C++ SC. The operating system 412 is suitably any operating system, such as Windows NT, Windows 2000, Windows XP, Unix, Linux, Macintosh or other operating system. The operating system 412 preferably acts as a network operating system and supports client-server network architecture.

The Client 416 is suitably either a Server or Client running any operating system, such as Windows NT, Windows 2000, Windows XP, Unix, Linux, Macintosh or other operating system. In addition, the Client 416 is suitably a Thick Client or Thin Client, as will be appreciated by those skilled in the art.

In the presently preferred embodiment, a user calls functionality of a SC 414. It should be noted that the term “user” should be limited to a human user. A user is suitably anything capable of triggering a call to a software component, such as a computer-readable code used during automation.

A software component 414 then preferably interacts with interface 406, which handles communications with the repository 404. For example, an interface 406 definition and a shared library are linked to a software component 414, which accesses the repository 404. A fixed location for the repository 404 files is suitably established using an operating system environment variable to provide flexibility. It should be noted that all functionality embodied in the SC 414 is alternatively built into the interface 406, thereby obviating the SC 414. The interface 406 suitably comprises functionality for querying the repository 404 structure, changing the repository 404 structure, adding folders to the repository 404, and deleting folders from the repository 404. In addition, the interface 406 also suitably comprises functionality for querying the markup based files, changing the markup based files, adding to the markup based files, and deleting from the markup based files. Furthermore, the interface 406 suitably comprises functionality for ensuring data integrity.

The SC 414 is suitably computer-readable code written in any language. The SC 414 is preferably compiled, pre-written code that defines interfaces that is callable to provide the functionality that the SC 414 encapsulates. SCs are typically packaged in “industry standard” ways such that they are callable from multiple languages, or from multiple environments. The computer-readable code, in the case of SCs is suitably a unit of independent deployment that has no persistent state. As such, it provides seamless integration with existing development tools, such Forte for Java or Microsoft Visual Studio. SCs are suitably used out-of-the-box, or extended and specialized by developers as desired. It should be noted that the SCs of the present invention are suitably designed for any language binding, such as Common Object Request Broker Architecture (“CORBA”), NET, COM, DCOM, C++, ActiveX, etc., as will be appreciated by those skilled in the art. In the presently preferred embodiment, the SC 414 is a C++ SC that is callable from multiple languages, or from multiple environments, or operating systems.

The SC 414 of the present invention suitably comprises functionality for interacting with an element (folder, file, etc.) of the repository 404, such as querying, creating, modifying, and deleting. Furthermore, the SC 414 suitably comprises functionality for performing a function on a key 108, or on name 104 and value 106 pairs 102 of markup based files in the repository 404. Such functionality suitably comprises querying, creating, modifying, and deleting. Table 1 provides a list of example functions callable through SC 414.

TABLE 1
Software Component Functions

| Method | Parameters | Description |
|---|---|---|
| GetValue | string specifying value path | Returns on the string object |
| | string object to hold value | the specified value. |
| GetValue | string specifying value path | Returns on the unsigned int |
| | unsigned integer to hold | the specified value. |
| | value | |
| GetValue | string specifying value path | Returns on the buffer the |
| | buffer to hold binary value | specified binary value. |
| | buffer size | |
| SetValue | string specifying value path | Sets the specified string value |
| | string value | or creates it if it does not |
| | | exist. |
| SetValue | string specifying value path | Sets the specified unsigned |
| | unsigned integer value | integer value or creates it if it |
| | | does not exist. |
| SetValue | string specifying value path | Sets the specified binary value |
| | buffer with binary value | or creates it if it does not |
| | buffer size | exist. |
| Enumerate | string specifying a key path | Enumerates the sub keys of |
| Keys | an object to hold the list of | the specified key. |
| | keys retrieved | |
| Enumerate | string specifying a key path | Enumerates the values |
| Values | an object to hold the list of | contained by the specified |
| | values retrieved | key. |
| DeleteValue | string specifying value path | Deletes specified value. |
| DeleteKey | string specifying key path | Deletes the last key in the |
| | | specified path. |

The path referenced in Table 1 is suitably a concatenation of names identifying the keys 108 to be traversed in order to reach either a sub-key 108 or a name 104. For example, referring to FIG. 3A, “DEPARTMENTS/HR/EMPLOYEES/John/title” is a path for the name 104 and 106 value pair 102 defining the job title of John, who is an employee in the HR department. Each of the methods in Table 1 performs a function on an element (key or name and value). Therefore, a path is required so that the SC 414 can locate the element upon which the function is to be performed. In the presently preferred embodiment, no distinction is made between directories, file names, and keys. Therefore, a path suitably includes directory information, file name information, and key information. In the example above, “DEPARTMENTS” references a directory, “HR” references the file “HR.xml” as well as the first key “HR” in the file “HR.xml”, “EMPLOYEES” references a key nested under the “HR” key, and “John” references a key nested under the “EMPLOYEES” key.

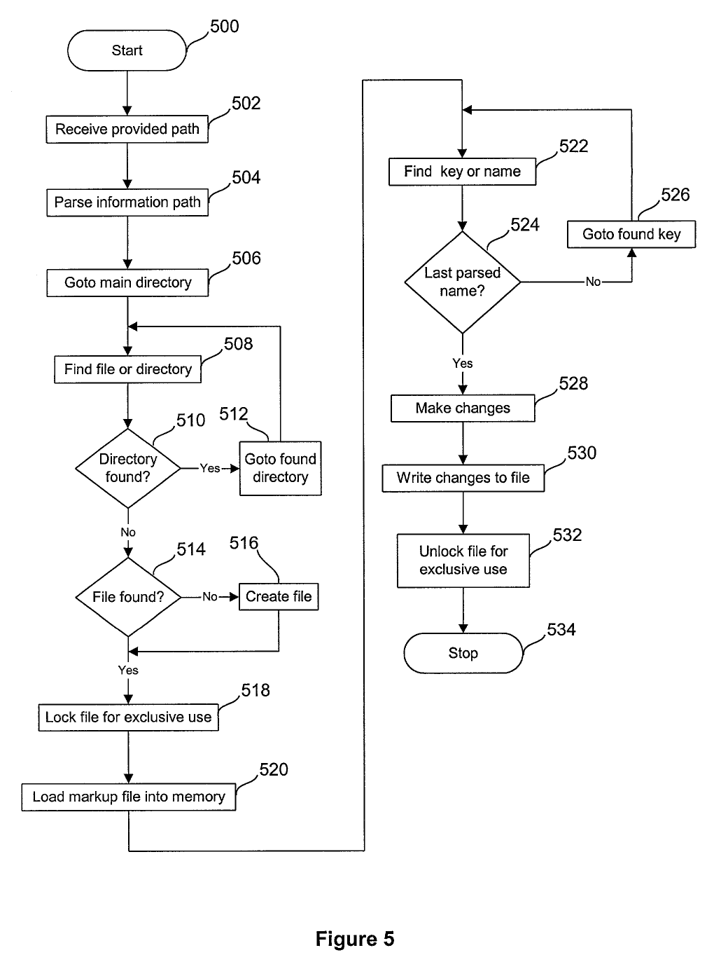

Turning now to FIG. 5, a flowchart generally depicting a method of interfacing with the hierarchical storage system of the present invention is provided. The general flow commences at start block 500, from which flow progresses to process block 502 wherein a provided path is received. The provided path is suitably received from a user, and may be provided through automation. Using the above example, the provided path is suitably represented by “ACME INC.\DEPARTMENTS\HR\”. Flow then progresses to process block 504 wherein the nature of the received path is parsed. After the received path is parsed, the parsed information is suitably used to determine the location of the object upon which a function is to be performed.

Flow continues to process block 506 wherein the procedure sets the main directory or root directory as the directory in which a search will be performed. In the example above, the main directory would be “ACME INC.” Progression then flows to process block 508 wherein a search is performed for either a file or directory matching the first parsed name. In the above example, a search within the location “ACME, INC.\” for a file or directory with the name “DEPARTMENTS” is suitably performed.

Progression then flows to decision block 510 wherein a determination is made whether a folder matching the parsed name was found. A positive determination at decision block 510 means that the target folder exists which causes progression to process block 512 wherein the search directory is then set to the found folder. Progression then loops back to process block 508 wherein another search is performed. The new search is preferably performed in the found folder for the parsed name following that matching the found folder. In other words, using the above example, a new search is suitably performed in the location “ACME INC.DEPARTMENTS\” for a file or folder matching the parsed name “HR”.

A negative determination at decision block 510 causes progression to decision block 514 wherein a determination is made whether a file is found matching the parsed name. A negative determination at decision block 514 causes progression to process block 516 wherein a new markup language based file is created having a name matching the parsed name. In this case, the file would suitably be named “HR.xml”. Progression then continues to process block 518. A negative determination at decision block 514 might also return an error instead of causing a new file to be created in order to more easily maintain data integrity and for the purposes of maintaining user simplicity.

A positive determination at decision block 514 causes progression to process block 518 wherein the found file is preferably locked for exclusive use. Locking the file allows for changes to be made to the file while ensuring integrity of data. Flow then continues to process block 520 wherein the markup based file is loaded into memory. In the presently preferred embodiment, a DOM XML parser is invoked to load the XML file into a memory tree which can then be traversed.

Progression then continues to process block 522 where a search is performed on the memory tree for a key 108 or name 104 matching the next parsed name following the name of the file loaded into memory. Flow continues to decision block 524 wherein a determination is made whether the found key 108 or name 104 is the last parsed name. A negative determination at decision block 524 means that there exists a nested key 108 or name 104 which is the target of any change to be made. Therefore, progression flows to process block 526 wherein the search location is then set to the found key 108 or name 104. Progression then loops back to process block 522, wherein a search is performed for the next parsed name nested within the key 108 or name 104.

A positive determination at decision block 524 means that the key 108 or name 104 which cannot be found within the memory tree is the last parsed name. In other words, the name 104 corresponding to information that is to be changed has been located within the memory tree.

Flow then continues to process block 528 wherein the appropriate changes are made to the memory tree. After making appropriate changes to the memory tree, progression continues to process block 530 wherein the memory tree is written back to the file that was locked for exclusive use in process block 518. Flow then continues to process block 532 wherein the file is unlocked, after which the process terminates at termination block 534.

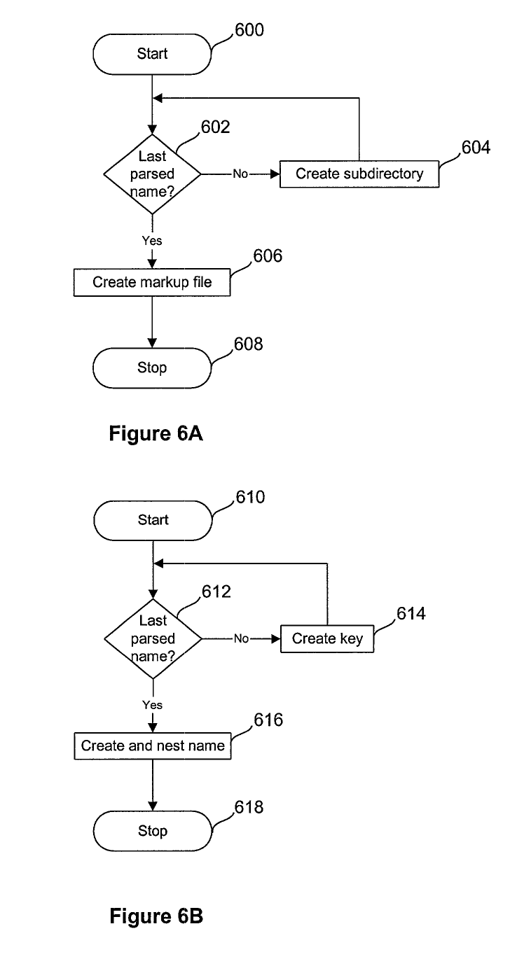

Turning now to FIG. 6A, illustrated is a basic flowchart of a method for creating elements in a hierarchical storage system of the present invention. When parsing the given path and a name in the sequence does not match any existing XML file or directory, a user might wish to add an element to the hierarchical storage system. The basic flow commences at start block 600, from which progression is made to decision block 602. At decision block 602, a determination is made whether the name not matching a file or directory is the last parsed name. A negative determination at decision block 602 means that the search is not complete, causing progression to flow to process block 604 wherein a subdirectory is created. Progression then loops back to decision block 602 wherein a determination is made whether the newly created subdirectory is the last parsed name.

A positive determination at decision block 602 means that the search is complete, causing progression to flow to process block 606 wherein a markup based file is created. In the presently preferred embodiment, an XML file is created. Progression then continues to termination block 608.

Turning now to FIG. 6B, illustrated is a basic flowchart of a method for creating elements in a hierarchical markup language file. When parsing the given path and a name in the sequence does not match any existing XML file or directory, a user might wish to add an element to the XML file. The basic flow commences at start block 610, from which progression is made to process block 612. At process block 612 a new element is created and nested as appropriate. The new element is suitably a key 108 or a name 104. Progression then continues to decision block 612, wherein a determination is made whether the newly created element is the last parsed name. A negative determination at decision block 612 means that the search is not complete, causing progression to loop back to process block 614 wherein another element is created matching the next parsed name.

A positive determination at decision block 612 means that the search is complete, causing progression to flow to process block 614 wherein a new name is created and nested. Flow then progresses to termination block 618.

Although the preferred embodiment has been described in detail, it should be understood that various changes, substitutions, and alterations can be made therein without departing from the spirit and scope of the invention as defined by the appended claims. It will be appreciated that various changes in the details, materials and arrangements of parts, which have been herein described and illustrated in order to explain the nature of the invention, may be made by those skilled in the area within the principle and scope of the invention as will be expressed in the appended claims.

What is claimed is:

1. A hierarchical information storage system comprising:
a repository comprising:
at least one first level folder for storing at least first and second data sets,
at least one first level markup based file stored within the at least one first level folder, the first level markup based file comprising information relative to at least a portion of the first data set,
at least one second level folder stored within the at least one first level folder for storing information relative to the second data set, and
at least one second level markup based file stored within the at least one second level folder, the second level markup based file comprising information relative to at least a portion of the second data set; and
an interface communicatively coupled to the repository for handling communications with the repository, the interface comprising computer readable code on a computer readable medium.

2. The system of claim 1 wherein the interface comprises computer readable code for providing a functionality selected from the group consisting of: querying the repository, changing the repository structure, adding to the repository, deleting from the repository, and combinations thereof.

3. The system of claim 1 wherein the interface comprises computer readable code for providing a functionality selected from the group consisting of: querying the markup based files, changing the markup based files, adding to the markup based files, deleting from the markup based files, and combinations thereof.

4. The system of claim 1 wherein the interface further comprises computer readable code for ensuring data integrity.

5. The system of claim 1 further comprising at least one software component for performing a function on an element of the repository.

6. The system of claim 5 wherein the function performed by the software component is selected from the group consisting of: querying, creating, modifying, deleting, and combinations thereof.

7. The system of claim 1 wherein the markup based files are selected from the group consisting of: SGML, XML, HTML, and combinations thereof.

8. The system of claim 1 wherein the markup based files comprise information stored in a form selected from the group consisting of: unsigned integers, text, binary data, and combinations thereof.

9. The system of claim 1 wherein the markup based files comprise at least one key and at least one name and value pair.

10. The system of claim 9 further comprising at least one software component for performing a function on name and value pairs.

11. The system of claim 10 wherein the function performed by the software component is selected from the group consisting of: querying, creating, modifying, deleting, and combinations thereof.

12. The system of claim 1 comprising a plurality of repositories.

13. A hierarchical information storage system in a network environment comprising:
a client communicatively coupled to a server;
at least one repository stored on the server comprising:
at least one first level folder for storing at least first and second data sets,
at least one first level markup based file stored within the at least one first level folder, the first level markup based file comprising information relative to at least a portion of the first data set,
at least one second level folder stored within the at least one first level folder for storing information relative to the second data set, and
at least one second level markup based file stored within the at least one second level folder, the second level markup based file comprising information relative to at least a portion of the second data set; and
an interface communicatively coupled to the at least one repository for handling communications with the repository, the interface comprising computer readable code on a computer readable medium.

14. The system of claim 13 wherein the interface is located on the server.

15. The system of claim 13 wherein the interface is located on the client.

16. The system of claim 13 wherein the interface comprises computer readable code for providing a functionality selected from the group consisting of: querying the repository, changing the repository structure, adding to the repository, deleting from the repository, and combinations thereof.

17. The system of claim 13 wherein the interface comprises computer readable code for providing a functionality selected from the group consisting of: querying the markup based files, changing the markup based files, adding to the markup based files, deleting from the markup based files, and combinations thereof.

18. The system of claim 13 wherein the interface further comprises computer readable code for ensuring data integrity.

19. The hierarchical information storage system of claim 13 further comprising at least one software component for performing a function on an element of the repository.

20. The system of claim 19 wherein the at least one software component is located on the server.

21. The system of claim 19 wherein the at least one software component is located on the client.

22. The hierarchical information storage system of claim 19 wherein the function A=?performed by the software component is selected from the group consisting of: querying, creating, modifying, deleting, and combinations thereof.

23. The system of claim 13 wherein the markup based files are selected from the group consisting of: SGML, XML, HTML, and combinations thereof.

24. The system of claim 13 wherein the markup based files comprise information stored in a form selected from the group consisting of: unsigned integers, text, binary data, and combinations thereof.

25. The system of claim 13 wherein the markup based files comprise at least one key and at least one name and value pair.

26. The system of claim 13 comprising a plurality of repositories.

27. A method for accessing a repository, the repository, the steps comprising:
receiving a command via an interface communicatively coupled to the repository specifying a value path;
searching for a file in the repository based on the value path, wherein the repository comprises at least one first level folder, at least one first level markup based file stored within the at least one first level folder, at least one second level folder stored within the at least one first level folder, and at least one second level markup based file stored within the at least one second level folder, the second level markup based file comprising information relative to at least a portion of the second data set, the searching beginning at the first level folder and continuing through additional level folders as necessary until a markup based file is found;
locking the file for exclusive use.
loading the markup file; and
finding a key within the markup file.

28. The method of claim 27 further comprising:
setting the value of the key within the markup file;
writing the change to the markup file to the repository; and
unlocking the file.

29. A computer-readable medium of instructions, comprising:
means adapted for receiving a command via an interface communicatively coupled to the repository specifying a value path;
means adapted for searching for a file in the repository based on the value path, wherein the repository comprises at least one first level folder, at least one first level markup based file stored within the at least one first level folder, at least one second level folder stored within the at least one first level folder, and at least one second level markup based file stored within the at least one second level folder, the second level markup based file comprising information relative to at least a portion of the second data set, the searching beginning at the first level folder and continuing through additional level folders as necessary until a markup based file is found;
means adapted for locking the file for exclusive use.
means adapted for loading the markup file; and
means adapted for finding a key within the markup file.

30. The computer-readable instructions of claim 29 further comprising:
means adapted for setting the value of the key within the markup file;
means adapted for writing the change to the markup file to the repository; and
means adapted for unlocking the file.
